(19) United States
(12) Patent Application Publication
(10) Pub. No.: US 2019/0079854 A1
(43) Pub. Date: Mar. 14, 2019

(54) SYSTEMS AND METHODS FOR EXECUTING TESTS

(71) Applicant: Facebook, Inc., Menlo Park, CA (US)

(72) Inventors: Victor Lassance Oliveira E Silva, London (GB); Ian Douglas Hegerty, Andover (GB); Daniel Bernhardt, London (GB); Luka Sterbic, London (GB); Shival Vashisht Maharaj, Mountain View, CA (US)

(21) Appl. No.: 15/702,181

(22) Filed: Sep. 12, 2017

(51) Int. Cl. G06F 11/36

(52) U.S. Cl. CPC G06F 11/3688; G06F 11/3692; G06F 11/368

(57) ABSTRACT

A computer-implemented method for executing tests may include (i) identifying a debugger that enables a developer to execute a test version of an application while collecting debug data about an execution of the test version of the application, (ii) retrieving, from a test configuration repository, a test configured to specify at least one predefined input and at least one expected output for the test version of the application, (iii) initiating an execution, via the debugger, of the test version of the application with the predefined input from the test retrieved from the test configuration repository, and (iv) determining, based on data collected by the debugger during the execution of the test version of the application with the predefined input, whether the execution of the test version of the application produced the expected output. Various other methods, systems, and computer-readable media are also disclosed.

### BACKGROUND

Testing is an important phase of development. Deploying a large product to thousands of users without thoroughly testing every conceivable use-case is a recipe for bugs and unhappy users. Many testing paradigms exist, such as unit tests that test individual functions, end-to-end tests that test the entire application, and manual tests that are run by quality assurance personnel with varying degrees of aid from automation. Despite this multitude of testing options, many bugs still make it past conventional testing schemes and into live production code where they frustrate users and cost vendors money, time, and reputation.

Many traditional systems for tests are entirely automated, producing pass/fail results that are opaque as to where exactly the failure occurred. Developers attempting to catch bugs that caused failure conditions in such tests may have to rewrite the tests to add additional logging or manually step through the code in a debugger to find the bug. Additionally, even the most thorough tests using developer-generated input may fail to catch the complicated situations that can arise from user input generated by hundreds or thousands of users. Furthermore, traditional testing frameworks may lack convenient processes for modifying input and output or viewing variables that change during the test. The instant disclosure, therefore, identifies and addresses a need for systems and methods for executing tests.

### SUMMARY

As will be described in greater detail below, the instant disclosure describes various systems and methods for executing tests by executing tests via the debugger, leveraging the logging and stepping abilities of the debugger allow developers greater insight into state changes during tests and providing flexibility in terms of inputs and expected outputs for tests.

In one example, a method for executing tests may include (i) identifying a debugger that enables a developer to execute a test version of an application while collecting debug data about an execution of the test version of the application, (ii) retrieving, from a test configuration repository, a test configured to specify at least one predefined input and at least one expected output for the test version of the application, (iii) initiating an execution, via the debugger, of the test version of the application with the predefined input from the test retrieved from the test configuration repository, and (iv) determining, based on data collected by the debugger during the execution of the test version of the application with the predefined input, whether the execution of the test version of the application produced the expected output.

In one embodiment, the computer-implemented method may further include (i) retrieving from the test configuration repository, in response to determining whether the execution of the test version of the application produced the expected output, an additional test configured to specify at least additional one predefined input that is based on an output produced by the execution of the test version of the application with the predefined input, (ii) initiating an additional execution, via the debugger, of the test version of the application with the additional predefined input from the additional test retrieved from the test configuration repository, and (iii) examining an additional output produced by the additional execution of the test version of the application with the additional predefined input. In some examples, the computer-implemented method may further include producing a report that may include the output produced by the execution of the test version of the application and the additional output produced by the additional execution of the test version of the application. In some embodiments, retrieving the additional test may include configuring the additional test to specify the additional predefined input that is based on the output produced by the execution of the test version of the application with the predefined input.

Additionally or alternatively, the computer-implemented method may further include identifying an additional debugger that enables the developer to execute a test version of an additional application and retrieving from the test configuration repository, in response to determining whether the execution of the test version of the application produced the expected output, an additional test configured to specify at least additional one predefined input that is based on an output produced by the execution of the test version of the application with the predefined input. In this embodiment, the computer-implemented method may further include initiating an additional execution, via the additional debugger, of the test version of the additional application with the additional predefined input from the additional test retrieved from the test configuration repository and examining an additional output produced by the additional execution of the test version of the additional application with the additional predefined input.

In some examples, the predefined input may include at least one instance of recorded user input from a deployed version of the application that is hosted on a production server and is accessible to end users. In one embodiment, the expected output may include a set of acceptable expected outputs, where each output within the set of acceptable expected outputs may include an individually acceptable expected output for the predefined input.

In one embodiment, initiating the execution, via the debugger, of the test version of the application with the predefined input from the test retrieved from the test configuration repository may include initiating a set of iterations of the execution of the test version of the application with the predefined input. In this embodiment, determining whether the execution of the test version of the application produced the expected output may include determining, based on data collected by the debugger during the set of iterations of the execution of the test version of the application with the predefined input, whether a portion of the iterations that produced the expected output meets a predefined threshold for successful iterations. In some examples, the computer-implemented method may further include alerting a user that the portion of the iterations that produced the expected output did not meet the predefined threshold for successful iterations.

In some examples, identifying the debugger may include configuring the test configuration repository to interface with the debugger. In one embodiment, initiating the execution, via the debugger, of the test version of the application with the predefined input from the test retrieved from the test configuration repository may include initiating a first execution on a first codebase that includes the test version of the application and a second execution on a second codebase that includes an additional test version of the application and determining whether the execution of the test version of the application produced the expected output by comparing an output produced by the first execution on the first codebase with an output produced by the second execution on the second codebase.

In one embodiment, determining, based on the data collected by the debugger during the execution of the test version of the application with the predefined input, whether the execution of the test version of the application produced the expected output may include identifying, based on the data collected by the debugger during the execution of the test version of the application, a component of the test version of the application that caused the execution of the test version of the application to not produce the expected output. In some examples, initiating the execution, via the debugger, of the test version of the application may include executing both a backend component of the test version of the application and a frontend component of the test version of the application. In one embodiment, the application may include a client component and initiating the execution, via the debugger, of the test version of the application may exclude executing the client component.

In one embodiment, the debugger may include a native part of a development interface in which the application is developed. Additionally or alternatively, the debugger may be a third party application to the test configuration repository that is not designed to interface with the test configuration repository.

In one embodiment, the computer-implemented method may further include logging, during the execution of the test version of the application, validation data for comparison with data about at least one execution of the application gathered from at least one external source that does not include the debugger. Additionally or alternatively, the computer-implemented method may further include measuring, during the execution of the test version of the application via the debugger, at least one metric of computing resource consumption during the execution of the test version of the application.

In addition, a corresponding system for executing tests may include several modules stored in memory, including (i) an identification module that identifies a debugger that enables a developer to execute a test version of an application while collecting debug data about an execution of the test version of the application, (ii) a retrieving module that retrieves, from a test configuration repository, a test configured to specify at least one predefined input and at least one expected output for the test version of the application, (iii) an initiation module that initiates an execution, via the debugger, of the test version of the application with the predefined input from the test retrieved from the test configuration repository, (iv) a determination module that determines, based on data collected by the debugger during the execution of the test version of the application with the predefined input, whether the execution of the test version of the application produced the expected output, and (v) at least one physical processor configured to execute the identification module, the retrieving module, the initiation module, and the determination module.

In some examples, the above-described method may be encoded as computer-readable instructions on a computer-readable medium. For example, a computer-readable medium may include one or more computer-executable instructions that, when executed by at least one processor of a computing device, may cause the computing device to (i) identify a debugger that enables a developer to execute a test version of an application while collecting debug data about an execution of the test version of the application, (ii) retrieve, from a test configuration repository, a test configured to specify at least one predefined input and at least one expected output for the test version of the application, (iii) initiate an execution, via the debugger, of the test version of the application with the predefined input from the test retrieved from the test configuration repository, and (iv) determine, based on data collected by the debugger during the execution of the test version of the application with the predefined input, whether the execution of the test version of the application produced the expected output.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an exemplary method for executing tests.

FIG. 2 is a block diagram of an exemplary system for executing tests.

FIG. 3 is a block diagram of an additional exemplary system for executing tests.

FIG. 4 is a diagram of an exemplary dashboard.

FIG. 5 is a diagram of an exemplary graphical user interface.

FIG. 6 is a flow diagram of an exemplary method for executing tests.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for executing tests. As will be explained in greater detail below, embodiments of the instant disclosure may improve the flexibility and effectiveness of automated and manual tests by executing tests via a debugger with which the developer is already familiar and which provides a wealth of fine-grained data collection to assist in pinpointing bugs. By executing tests in this way, the systems and methods described herein may be able to improve the effectiveness of tests at replicating and/or catching bugs, thereby reducing the number of bugs that are released in production code and minimizing the amount of time taken to fix bugs that are discovered in production code. In addition, the systems and methods described herein may improve the functioning of a computing device by detecting bugs in computing code with increased effectiveness. These systems and methods may also improve the field of automated testing by increasing the flexibility and effectiveness of automated tests.

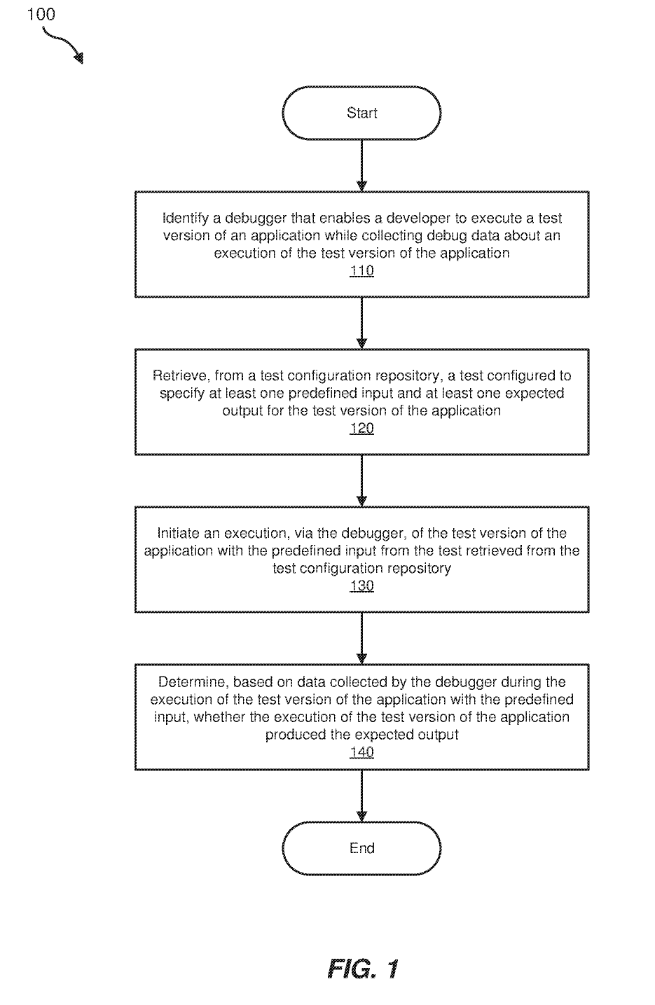

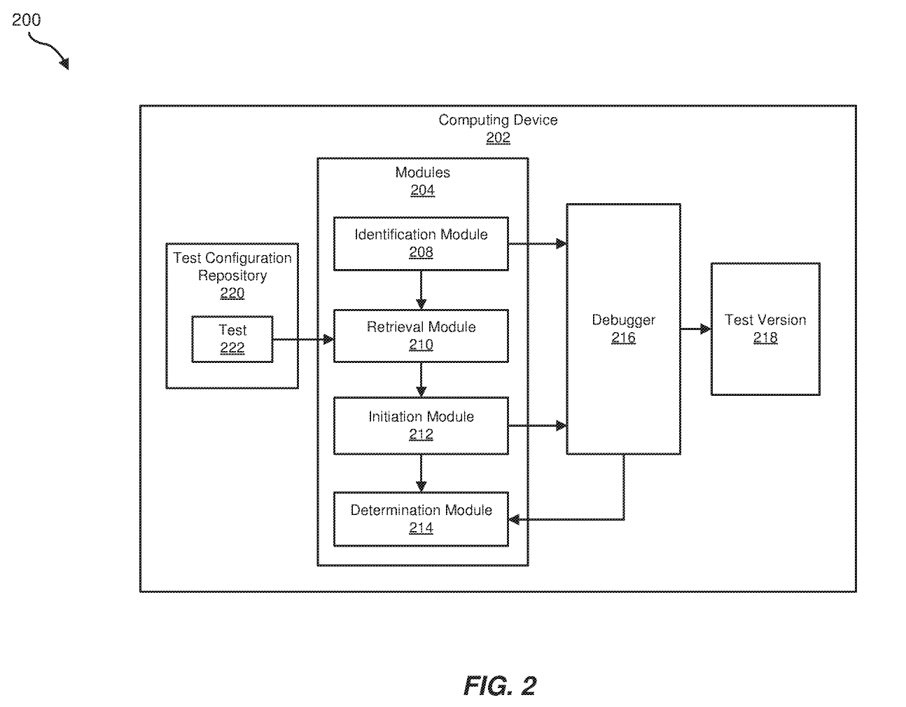

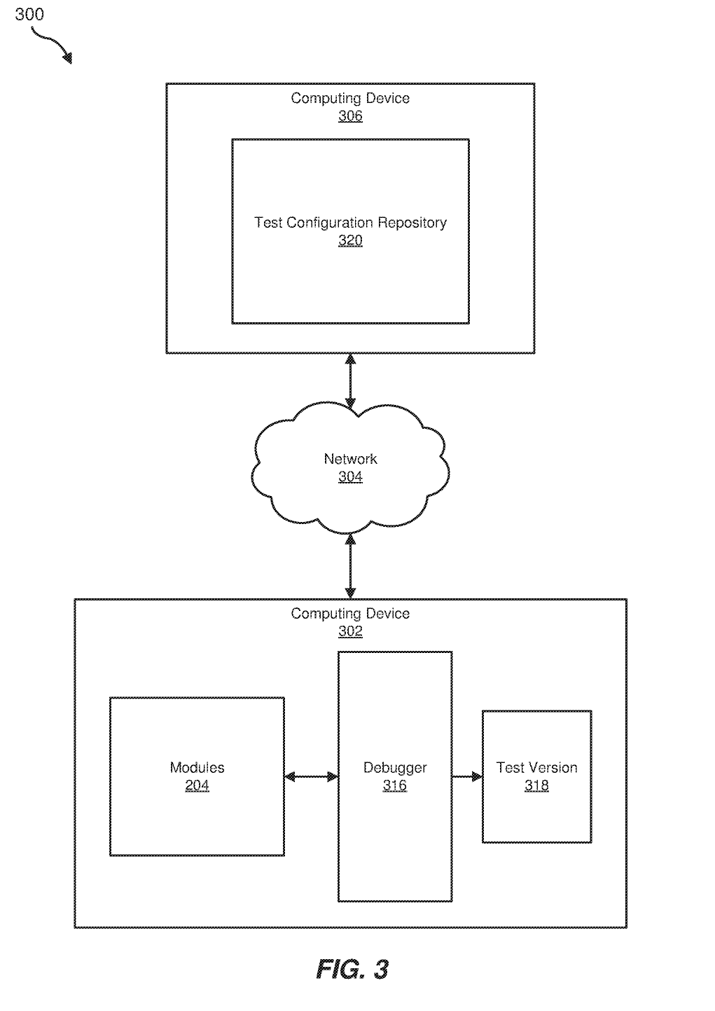

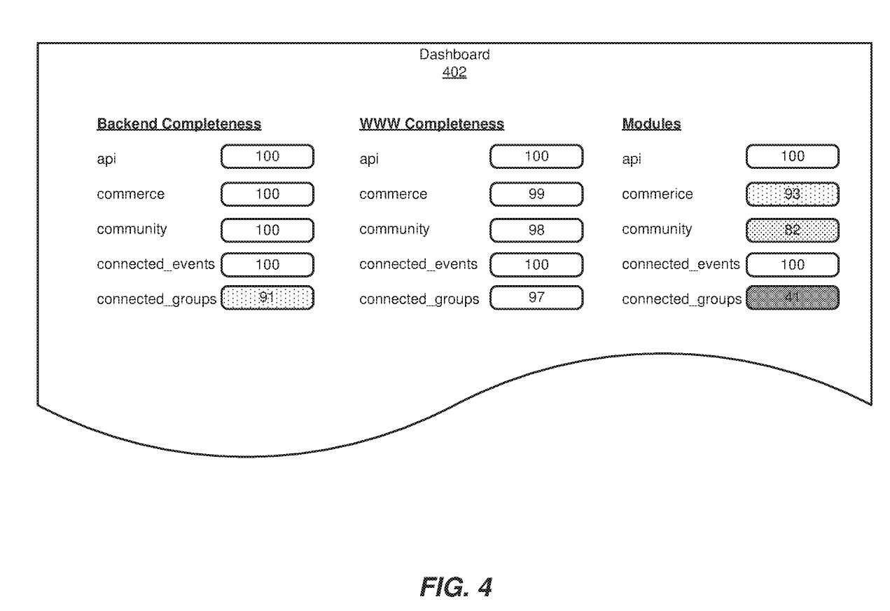

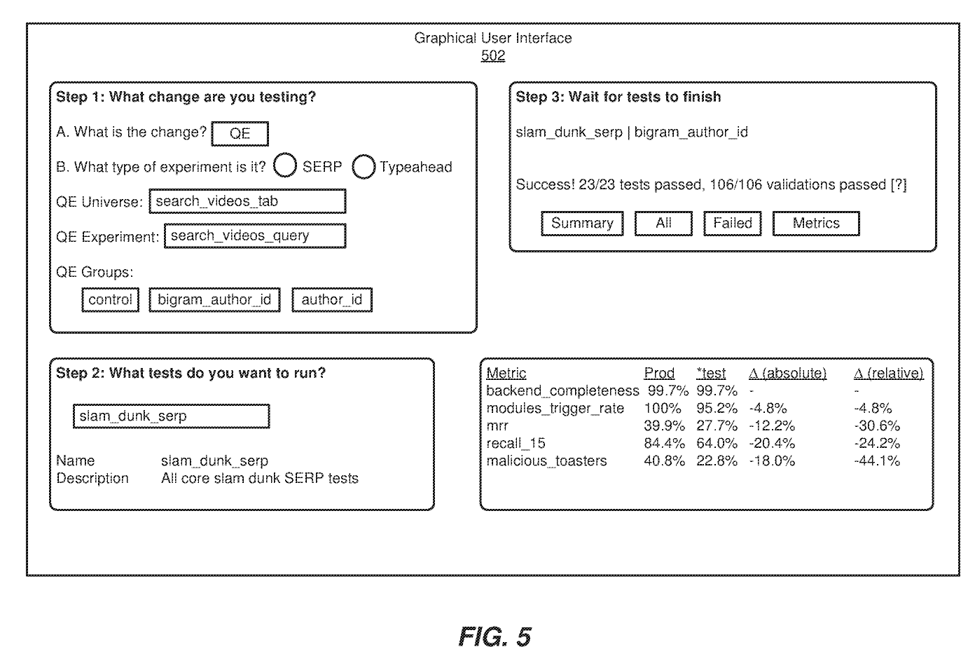

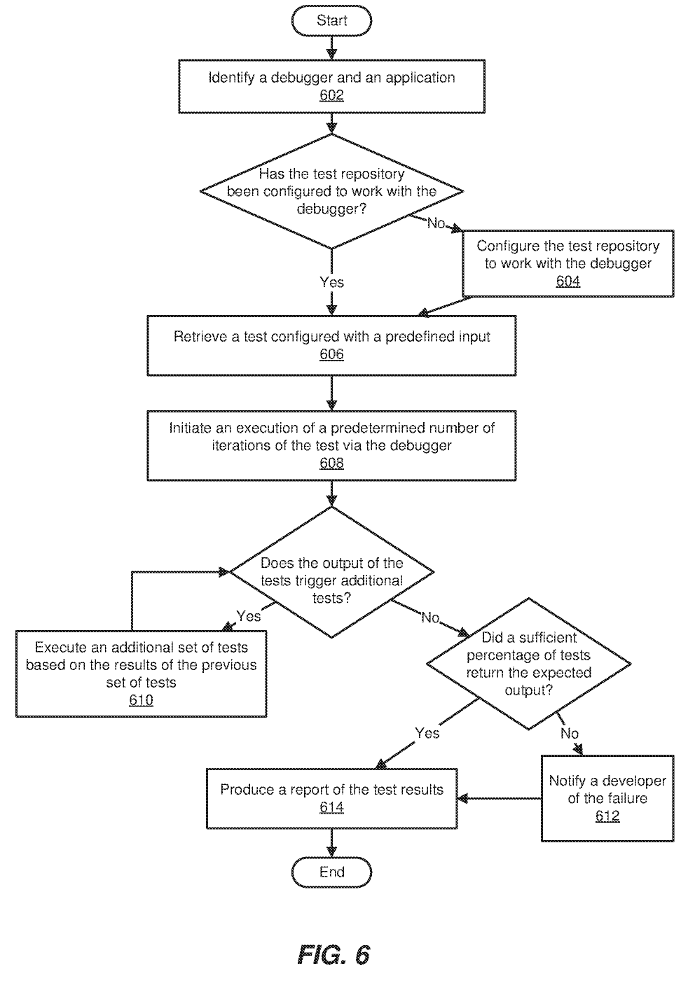

The following will provide, with reference to FIGS. 1 and 6, detailed descriptions of exemplary methods for executing tests. Detailed descriptions of corresponding exemplary systems for executing tests will be provided in connection with FIGS. 2 and 3. In addition, detailed descriptions of exemplary dashboards and graphical user interfaces will be provided in connection with FIGS. 4 and 5, respectively.

FIG. 1 is a flow diagram of an example computer-implemented method 100 for executing tests. The steps shown in FIG. 1 may be performed by any suitable computer-executable code and/or computing system, including system 200 in FIG. 2, system 300 in FIG. 3, and/or variations or combinations of one or more of the same. In one example, each of the steps shown in FIG. 1 may represent an algorithm whose structure includes and/or is represented by multiple sub-steps, examples of which will be provided in greater detail below.

As illustrated in FIG. 1, at step 110, one or more of the systems described herein may identify a debugger that enables a developer to execute a test version of an application while collecting debug data about an execution of the test version of the application.

The term “application,” as used herein, generally refers to any software, code, program, and/or executable capable of receiving input and producing output. In some embodiments, an application may be a standalone program, such as an executable file. In other embodiments, an application may be a web application that is hosted on one or more servers. In one example, an application may be a social media platform that enables users to create profiles and communicate with other users. In some examples, an application may have several versions. For example, an application may have a production version that is deployed to end users, a different production version that is deployed on a different platform, and/or one or more test versions. In some embodiments, an application may include several components. For example, an application may include a backend component, a frontend component, and/or a client component.

The term “test version,” as used herein, generally refers to any instance of an application that is not currently deployed to end users. In one example, a test version of an application may be identical to a production version of the application that is deployed to users. In another example, a test version of an application may include code and/or configuration changes that are not currently deployed in a production version of the application. In some examples, a test version of an application may be stored in a version control system that is remotely accessible by a number of developers. In other examples, a test version may be stored locally on a developers' computing system.

The term “debugger,” as used herein, generally refers to any tool used to debug an application. In one embodiment, the debugger may include a debug interface that receives input e.g., a search query) and returns debug data (e.g., the different computation steps the system executed together with the actual output). In some embodiments, a debugger may include a web service and/or a user interface for a web service. In some examples, the debugger may output a machine-readable representation of debug data. Additionally or alternatively, a debugger may include a native part of a development interface in which the application is developed. For example, an integrated development environment may include a debugger. In another example, a development interface may be configured to allow a developer to debug applications from the console. In some embodiments, a debugger may have various features designed to enable a developer to effectively debug an application, such as the ability to step through code one line at a time, the ability to see the line of code and/or function currently being executed during an execution of the application, the ability to set breakpoints in code that will pause the execution of the application, the ability to view the values for variables at each point during the execution of the application, and/or the ability to set fine-grained logging controls on what data is collected during the execution of the application. In one embodiment, the debugger may be a third party application to the test configuration repository that is not designed to interface with the test configuration repository. For example, the test configuration repository may be a separate application from the debugger and/or development environment and/or may be created by a different vendor than the vendor of the debugger and/or development environment.

The term “debug data,” as used herein, generally refers to any data collected by a debugger during the execution of an application. In one example, debug data may include data about the current value of one or more variables that is displayed by the debugger at each step of the execution of an application (e.g., during the execution of each individual function and/or line of code). In another example, debug data may include data that is logged by the debugger during the execution of the application and/or displayed after the completion of the execution of the application. For example, debug data may include the number of errors generated by the application, the number of times a particular function was called, and/or resource consumption metrics.

The term “developer,” as used herein, generally refers to any person involved in the development process of an application. In one example, a developer may be a person with the permissions to edit the code and/or configuration of an application. In another example, a developer may be a quality assurance tester who is responsible for testing an application.

The systems described herein may identify a debugger in a variety of ways and/or contexts. In some embodiments, the systems described herein may automatically detect any local debuggers installed on a computing system. In other embodiments, a debugger may be a web service hosted remotely on a server. In some embodiments, a user may direct the systems described herein to a particular debugger. For example, a user may direct the systems described herein to a web service that includes a debug interface.

In some embodiments, the systems described herein may configure the test configuration repository to interface with the debugger. In one embodiment, the systems described herein may generate customized instructions for a developer to configure the test configuration repository to interface with the debugger. In some examples, the systems described herein may enable a developer to select tests from the test configuration repository via a user interface of the debugger. Additionally or alternatively, the systems described herein may enable a developer to select the debugger and/or one or more codebases tested by the debugger from a user interface of the test configuration repository.

At step 120, one or more of the systems described herein may retrieve, from a test configuration repository, a test configured to specify at least one predefined input and at least one expected output for the test version of the application.

The term “test,” as used herein, generally refers to any one or more inputs that are correlated with one or more expected outputs for an application and/or a part of an application. In some embodiments, a test may provide input to and/or record output from a single function and/or series of functions. In some embodiments, a test may provide input to and/or record output from a frontend component of the application. Additionally or alternatively, a test may provide input to and/or record output from a user interface of the application.

The term “test configuration repository,” as used herein, generally refers to any form of data storage that stores one or more tests and/or configurations for tests. In some embodiments, a test configuration repository may also include an application that interfaces with the debugger, for example by providing input and/or output information about the tests to the debugger to enable the tests to be automatically executed via the debugger. In one embodiment, a test configuration repository may include a user interface that enables a user to configure, modify, create, and/or manage tests stored in the test configuration repository. In some embodiments, a test configuration repository may be designed so that a user does not have to modify any of the code of the test configuration repository in order to configure the test configuration repository to interface with a debugger and/or manage tests stored within the test configuration repository.

The term “predefined input,” as used herein, generally refers to any data, application state, and/or instructions that can be provided to an application. In some examples, predefined input may include data in the form of one or more strings, integers, hashes, and/or other data structures. In some examples, predefined input may include instructions such as function calls, user interface element interactions (e.g., mouse clicks), form submissions, and/or console commands. In some embodiments, a test may have several versions of predefined input that a developer may select among when configuring the test. For example, a test for a search function may include several different search terms. In some examples, predefined input may include at least one instance of recorded user input from a deployed version of the application that is hosted on a production server and is accessible to end users. For example, logging tools on the production server may log a series of data inputs and/or instructions sent by a user and the predefined input may reproduce that series of data inputs and/or instructions. In one example, a user may use a particular search form on a website to search for a particular search term and may then view results located in a specific area of the website. In this example, the predefined input may include the search form and/or search function called by the search form, the search term, account data from the user's account, and/or the area of the website where the user navigated to find the search results.

The term “expected output,” as used herein, generally refers to any data and/or application state produced by an application in response to receiving input. In some embodiments, output may be expected if the output is the predictable and/or logical result of the action of a function on the predefined input. In some examples, expected output may be specified by a developer. In other examples, expected output may be defined based on previous observed output. In some examples, a single expected output may correlate to a single predefined input. For example, if the predefined input is a string of text and a call to a function that posts the text to a user's profile, the expected output may be that the user's profile will now contain that exact string of text. In other examples, the expected output may include a set of acceptable expected outputs, where each output within the set of acceptable expected outputs may be an individually acceptable expected output for the predefined input. For example, if the predefined input is a search term and a call to a search function, acceptable expected outputs may vary based on the user's data and/or whether the search term is trending globally at the time. In one example, a user searching for “Bill” who is connected to the profile of a user named “Bill Smith” may have the expected output that “Bill Smith” will be the top search result returned while a user who is not connected to Bill Smith but who is connected to a user named “Bill Green” may have the expected output that “Bill Green” will be the top search result when searching for “Bill,” and/or a user who is not connected to either Bill Green or Bill Smith may expect either one to be the top search result for the search term “Bill.” In another example, a search for “gaga” may be expected to return results relevant to the performer Lady Gaga when the performer is trending in the news but may otherwise be expected to return results related to baby products.

The systems described herein may retrieve the test in a variety of ways and/or circumstances. In some embodiments, the systems described herein may retrieve a test from a test configuration repository located on the same computing device as the debugger and/or the test version of the application. In other embodiments, the systems described herein may retrieve a test from a test configuration repository located on a separate computing device from the debugger and/or the test version of the application. In one embodiment, the test configuration repository may be hosted on a test configuration repository server. In another embodiment, the test configuration repository may be part of a local application on a computing device used for application development and/or testing.

In some embodiments, the systems described herein may configure a test retrieved from the test configuration repository. For example, a test may have a number of different versions of predetermined input and the systems described herein may configure the test by selecting a subset of the versions of the predetermined input. In one example, a test for a search system may have data for one hundred user accounts that could launch the search and one thousand search terms that could be inputted to the search system. In this example, the systems described herein may configure the test by selecting one or more user accounts and/or search terms to use as input for a particular iteration and/or set of iterations of the test.

At step 130, one or more of the systems described herein may initiate an execution, via the debugger, of the test version of the application with the predefined input from the test retrieved from the test configuration repository.

The systems described herein may initiate an execution, via the debugger, of the test version of the application with the predefined input from the test retrieved from the test configuration repository in a variety of ways and/or contexts. In some examples, a developer may initiate the execution of the test version of the application. For example, a quality assurance developer may initiate the execution of the test version of the application in order to reproduce a bug. In other examples, automated systems may initiate the execution of the test version of the application. For example, the systems described herein may schedule the test to run once per hour, day, and/or week. In another example, the systems described herein may schedule a hundred iterations of the test with different configurations (e.g., different versions of the predefined input and/or different starting application states) to run once per day. Additionally or alternatively, automated systems may initiate the execution of the test in response to a developer committing a change to a code repository.

In some examples, the systems described herein may initiate the execution, via the debugger, of the test version of the application by executing both a backend component of the test version of the application and a frontend component of the test version of the application. The term “backend component,” as used herein, generally refers to any component of an application not directly interacted with by an end user. In some examples, a backend component of an application may be hosted on a server. The term “frontend component,” as used herein, generally refers to any component of an application that interfaces between a user and a backend component. In some embodiments, a frontend component may include a web layer and/or a business logic layer. In some embodiments, a frontend component may not include a client component. The term “client component,” as used herein, generally refers to any user interface used directly by an end user to interact with an application, such as a graphical user interface. In some examples, a client component may include client-side coding such as JAVASCRIPT and/or a mobile application.

In one embodiment, the application may include a client component and initiating the execution, via the debugger, of the test version of the application may not include executing the client component. In some examples, the systems described herein may provide input data directly to functions rather than providing input data to user interface elements that make calls to those functions. In one example, a test of a search function may send a request to a server that hosts the search function and that is formatted like a request from a web browser rather than displaying the search page in a web browser window and inputting the string into a form element associated with the search and then submitting the form via a mouse click action. In some embodiments, the systems described herein may leverage features of the debugger to send input to a frontend and/or backend component of the application without going through a client component of the application. For example, a debugger may enable input to be provided directly to a function and/or component of the application. By avoiding sending input via a client component of the application, the systems described herein may consume fewer computing resources while performing tests and/or may isolate bugs in frontend and/or backend components of applications without confounding results introduced by potentials bugs in client components.

In some embodiments, the systems described herein may only execute tests on versions of an application that include the client component if the tests meet certain criteria. For example, the systems described herein may execute stable tests that seldom fail on versions of the application that include the backend component, frontend component, and client component. Additionally or alternatively, the systems described herein may execute critical tests, the failure of which indicates serious problems with the application, on one or more versions of the application that include the client component.

In one embodiment, the systems described herein may log, during the execution of the test version of the application, validation data for comparison with data about at least one execution of the application gathered from at least one external source that does not include the debugger. For example, a version of an application may log various data such as requests received, errors generated, and/or resources consumed. In this example, the systems described herein may log this same data during an execution of the application via the debugger and then compare the data logged by the external source with the data logged during the execution via the debugger to ensure that the external source is accurately logging data.

At step 140 one or more of the systems described herein may determine, based on data collected by the debugger during the execution of the test version of the application with the predefined input, whether the execution of the test version of the application produced the expected output.

The systems described herein may determine whether the execution of the test version of the application produced the expected output in a variety of ways and/or contexts. For example, the systems described herein may compare output produced by the execution of the test version of the application with the expected output. In some examples, the systems described herein may compare output produced by executing the test on two different versions of the application.

In one embodiment, the systems described herein may determine, based on the data collected by the debugger during the execution of the test version of the application with the predefined input, a component of the test version of the application that caused the execution of the test version of the application to not produce the expected output. For example, the systems described herein may determine that a backend component of the application caused the failure of the test. In another example, the systems described herein may determine that a specific function caused the failure of the test. In one example, the systems described herein may determine that a specific line of code caused the failure of the test.

In some embodiments, the systems described herein may all execute on a single computing device. For example, as illustrated in FIG. 2, a system 200 may include a computing device 202 that hosts a set of modules 204 that may consist of an identification module 208, a retrieval module 210, an initiation module 212, and/or a determination module 214. In some examples, identification module 208 may identify a debugger 216 on computing device 202. In one example, retrieval module 210 may retrieve a test 222 from a test configuration repository 220 that is also hosted on computing device 202. In some examples, initiation module 212 may initiation an execution of a test version 218 of an application via debugger 216 using input provided by test 222 and/or determination module 214 may determine whether the execution of test version 218 of the application via debugger 216 produced the output expected by test 222.

In another embodiment, the systems described herein may be hosted on different computing devices. For example, as illustrated in FIG. 3, a system 300 may include a computing device 302 in communication with a computing device 306 via a network 304. In some examples, computing device 302 may host modules 204, a debugger 316, and/or a test version 318 of an application. In some embodiments, computing device 302 may represent a personal computing device. In other embodiments, computing device 302 may represent a server that hosts a code repository and/or debug interface for the application. In one example, computing device 306 may host a test configuration repository 320. In some embodiments, computing device 306 may represent one or more servers.

In one embodiment, the systems described herein may initiate a set of iterations of the execution of the test version of the application with the predefined input and may determine whether the execution of the test version of the application produced the expected output by determining, based on data collected by the debugger during the set of iterations of the execution of the test version of the application with the predefined input, whether a portion of the set of iterations that produced the expected output meets a predefined threshold for successful iterations. For example, a test of a search function may provide 1,000 search terms as input and may expect a specific corresponding result to be the first search result returned for each search term. In this example, if 950 search terms produce the expected search results but 50 search terms do not and the predefined threshold is 90%, the systems described herein may determine that the test has passed.

In some embodiments, the predefined threshold may be a static threshold, such as 90%, 95%, or 98%. In other embodiments, the predetermined threshold may be based on previous results over a period of time. In some examples, the predefined threshold may be set some percentage below the average amount of expected results produced by the past few executions of a set of iterations of the test. For example, if the previous three executions of a set of iterations of the test produced the expected output in 96%, 94%, and 95% of iterations, respectively, the predefined threshold for the next set of iterations may be 90% while if the previous three executions of a set of iterations of the test produced the expected output in 89%, 90%, and 90% of iterations, respectively, the predefined threshold for the next set of iterations may be 85%. In this example, if the test suddenly starts producing the expected output significantly less often than previously, this may indicate that a new bug has been introduced to the application.

In some examples, the systems described herein may alert a user that the portion of the set of iterations that produced the expected output did not meet the predefined threshold for successful iterations. For example, the systems described herein may send an email, test message, and/or other type of electronic message to a user. In another embodiment, the systems described herein may display an alert on a dashboard and/or create a report. Additionally or alternatively, the systems described herein may display a pop-up notification.

In some examples, the systems described herein may display the results of the last set of executions of each test in a dashboard. FIG. 4 is an illustration of an example dashboard 402 that includes tests of various components of an application. As illustrated in FIG. 4, the systems described herein may execute different tests of each component and/or track test results across components to determine which components produce errors. In some examples, the systems described herein may display a dashboard with color-coded percentages indicating the rates at which different tests produced the expected output.

In some examples, the systems described herein may execute additional tests in response to the results of the first test. For example, if a test of multiple components of an application does not produce the expected output, the systems described herein may retrieve and initiate the execution of a test of one of the components of the application in order to isolate the component with the bug. In another example, if the systems described herein execute 100 iterations of the same test and 15 iterations fail to pass, the systems described herein may execute the 15 failing iterations an additional time, potentially with more logging, on a different code base, and/or under manual supervision.

In another example, the systems described herein may run the same test on a different version of the application (e.g., a prior version and/or a version designed for another platform) in order to determine whether the test exhibits the same behavior. In some examples, the first execution of the application with the predefined input from the original test may take place on a first codebase and the second execution of the application with the predefined input from the additional test may take place on a second code base. In some embodiments, the systems described herein may compare the output produced by the first execution on the first codebase with the output produced by the second execution on the second codebase to determine whether the tests produced the same results.

In some embodiments, the systems described herein may initiate the execution of an additional test via an additional debugger. For example, a version of an application created for a mobile device may be developed in a different development environment than a version of an application created for display in a browser, and each development environment may have a different debugger. In another example, a backend component of an application may be developed in a different environment than a frontend component of an application. In one example, the systems described herein may execute a test on a frontend component of an application via one debugger and may then execute an additional test based on the results of the first test on a backend component of the application via a different debugger.

In some examples, the systems described herein may configure predefined input for the additional test based on the output of the first test. For example, a test of a profile page posting function may produce a post with a specific string and a test of a search function may search for that specific string to determine whether the profile page that now contains the string appears as a search result.

In some examples, the systems described herein may produce a report that includes the output produced by the execution of the test version of the application and the additional output produced by the additional execution of the test version of the application. In some examples, the report may include information about executions of multiple iterations of each test. In some examples, the report may include the percentage of successful test results produced by the different executions on different codebases to enable a developer to determine whether the number of passing tests has improved or declined since making a change to a version of the application.

In one embodiment, the systems described herein may measure, during the execution of the test version of the application via the debugger, at least one metric of computing resource consumption during the execution of the test version of the application. For example, the systems described herein may measure the amount of memory used by the application and/or the amount of computer processor unit power used by the application. In one embodiment, the systems described herein may measure the speed of the execution of different components and/or functions of the application. Additionally or alternatively, the systems described herein may measure other types of metrics. For example, the systems described herein may measure rates of errors, invocations of various functions, and/or other data points. In some embodiments, the systems described herein may enable a developer to create a user-defined function to measure custom metrics. In one embodiment, the systems described herein may enable a developer to define a new metric based on responses from the debugger by referencing the names of functions in the source code for the application. In some examples, the systems described herein may enable a developer to define the expectations and/or measurements to test, measure, and/or track an application and/or feature inside a test environment, using the debugger as a proxy of the application's behavior and/or output.

In some embodiments, the systems described herein may present a developer with a graphical user interface that the developer may use to retrieve tests from a test configuration repository, initiate tests via a debugger, and/or view results of completed tests. For example, FIG. 5 illustrates an example graphical user interface 502 that enables a developer to select one or more versions of the application on which to run tests and one or more tests to run. In some examples, graphical user interface 502 may also display metrics after the tests are completed.

In some embodiments, the systems described herein may make a series of determinations about which step to execute next. FIG. 6 is a flow diagram of an example decision flow for executing tests via a debugger. As illustrated in FIG. 6, at step 602, the systems described herein may identify a debugger and an application. The systems described herein may then determine whether or not the test configuration repository has been configured to work with the debugger. If not, at step 604, the systems described herein may configure the test configuration repository to work with the debugger. At step 606, the systems described herein may retrieve a test from the test configuration repository that is configured with a predefined input. At step 608, the systems described herein may execute a predetermined number of iterations of the test via the debugger. If the output of the test triggers additional tests, at step 610, the systems described herein may execute an additional set of tests based on the results of the previous set of tests. The systems described herein may continue repeating step 610 as long as the additional tests trigger further additional tests. If no more tests are triggered, the systems described herein may determine whether a sufficient percentage of the tests returned the expected output. If not, at step 612, the systems described herein may notify a developer of the failure. At step 614, the systems described herein may produce a report of the test results.

As explained in connection with method 100 above, the systems and methods described herein may enable developers to more efficiently and effectively find bugs in applications by executing tests via a debugger. By executing multiple iterations of the same test with different input, the systems described herein may enable developers to determine whether a bug is large (causing a high percentage of test cases to fail) or small (causing a small percentage of test cases to fail), what specific input or types of input trigger the bug, in which version of the codebase the bug is preset, and/or in which component of the application the bug is present. In addition, by collecting user data from production versions of the application and replaying that data via the debug interface, the systems described herein may enable developers to accurately reproduce bugs experienced by users and/or tests systems that behave in different ways based on user settings and/or data. By chaining tests together so that additional tests are launched based on the outcomes of other tests, the systems described herein may enable developers to track expectations in all layers of the stack, quickly diagnose failures, and extensively test features in a short period of time with little manual overhead. By enabling developers to find and fix bugs more quickly and efficiently, the systems described herein may improve the stability, reliability, and/or performance of applications.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive test data to be transformed, transform the test data into input for a debugger, output a result of the transformation to a debugger, use the result of the transformation to execute a test via the debugger, and store the result of the transformation to determine the success or failure of a test. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying a debugger that enables a developer to execute a test version of an application while collecting debug data about an execution of the test version of the application;
retrieving, from a test configuration repository, a test configured to specify at least one predefined input and at least one expected output for the test version of the application, wherein the at least one predefined input comprises at least one instance of recorded user input;
initiating an execution, via the debugger, of the test version of the application with the predefined input from the test retrieved from the test configuration repository; and
determining, based on data collected by the debugger during the execution of the test version of the application with the predefined input, whether the execution of the test version of the application produced the expected output.

2. The computer-implemented method of claim 1, further comprising:
retrieving from the test configuration repository, in response to determining whether the execution of the test version of the application produced the expected output, an additional test configured to specify at least one additional predefined input that is based on an output produced by the execution of the test version of the application with the predefined input;
initiating an additional execution, via the debugger, of the test version of the application with the additional predefined input from the additional test retrieved from the test configuration repository; and
examining an additional output produced by the additional execution of the test version of the application with the additional predefined input.

3. The computer-implemented method of claim 2, further comprising producing a report that comprises the output produced by the execution of the test version of the application and the additional output produced by the additional execution of the test version of the application.

4. The computer-implemented method of claim 2, wherein retrieving the additional test comprises configuring the additional test to specify the additional predefined input that is based on the output produced by the execution of the test version of the application with the predefined input.

5. The computer-implemented method of claim 1, further comprising:
identifying an additional debugger that enables the developer to execute a test version of an additional application;
retrieving from the test configuration repository, in response to determining whether the execution of the test version of the application produced the expected output, an additional test configured to specify at least additional one predefined input that is based on an output produced by the execution of the test version of the application with the predefined input;
initiating an additional execution, via the additional debugger, of the test version of the additional application with the additional predefined input from the additional test retrieved from the test configuration repository; and
examining an additional output produced by the additional execution of the test version of the additional application with the additional predefined input.

6. The computer-implemented method of claim 1, wherein the at least one instance of recorded user input is from a deployed version of the application that is hosted on a production server and is accessible to end users.

7. The computer-implemented method of claim 1, wherein the expected output comprises a set of acceptable expected outputs, wherein each output within the set of acceptable expected outputs comprises an individually acceptable expected output for the predefined input.

8. The computer-implemented method of claim 1, wherein:
initiating the execution, via the debugger, of the test version of the application with the predefined input from the test retrieved from the test configuration repository comprises initiating a plurality of iterations of the execution of the test version of the application with the predefined input; and
determining whether the execution of the test version of the application produced the expected output comprises determining, based on data collected by the debugger during the plurality of iterations of the execution of the test version of the application with the predefined input, whether a portion of the plurality of iterations that produced the expected output meets a predefined threshold for successful iterations.

9. The computer-implemented method of claim 8, further comprising alerting a user that the portion of the plurality of iterations that produced the expected output did not meet the predefined threshold for successful iterations.

10. The computer-implemented method of claim 1, wherein identifying the debugger comprises configuring the test configuration repository to interface with the debugger.

11. The computer-implemented method of claim 1, wherein:
initiating the execution, via the debugger, of the test version of the application with the predefined input from the test retrieved from the test configuration repository comprises initiating a first execution on a first codebase that comprises the test version of the application and a second execution on a second codebase that comprises an additional test version of the application; and
determining whether the execution of the test version of the application produced the expected output comprises comparing an output produced by the first execution on the first codebase with an output produced by the second execution on the second codebase.

12. The computer-implemented method of claim 1, further comprising measuring, during the execution of the test version of the application via the debugger, at least one metric of computing resource consumption during the execution of the test version of the application.

13. The computer-implemented method of claim 1, wherein determining, based on the data collected by the debugger during the execution of the test version of the application with the predefined input, whether the execution of the test version of the application produced the expected output comprises identifying, based on the data collected by the debugger during the execution of the test version of the application, a component of the test version of the application that caused the execution of the test version of the application to not produce the expected output.

14. The computer-implemented method of claim 1, wherein initiating the execution, via the debugger, of the test version of the application comprises executing both a backend component of the test version of the application and a frontend component of the test version of the application.

15. The computer-implemented method of claim 1, wherein:
the application comprises a client component; and
initiating the execution, via the debugger, of the test version of the application does not comprise executing the client component.

16. The computer-implemented method of claim 1, wherein the debugger comprises a native part of a development interface in which the application is developed.

17. The computer-implemented method of claim 1, wherein the debugger comprises a third party application to the test configuration repository that is not designed to interface with the test configuration repository.

18. The computer-implemented method of claim 1, further comprising logging, during the execution of the test version of the application, validation data for comparison with data about at least one execution of the application gathered from at least one external source that does not comprise the debugger.

19. A system comprising:
an identification module, stored in memory, that identifies a debugger that enables a developer to execute a test version of an application while collecting debug data about an execution of the test version of the application;
a retrieving module, stored in memory, that retrieves, from a test configuration repository, a test configured to specify at least one predefined input and at least one expected output for the test version of the application, wherein the at least one predefined input comprises at least one instance of recorded user input;
an initiation module, stored in memory, that initiates an execution, via the debugger, of the test version of the application with the predefined input from the test retrieved from the test configuration repository;
a determination module, stored in memory, that determines, based on data collected by the debugger during the execution of the test version of the application with the predefined input, whether the execution of the test version of the application produced the expected output; and
at least one physical processor configured to execute the identification module, the retrieving module, the initiation module, and the determination module.

20. A non-transitory computer-readable medium comprising one or more computer-readable instructions that, when executed by at least one processor of a computing device, cause the computing device to:
identify a debugger that enables a developer to execute a test version of an application while collecting debug data about an execution of the test version of the application;
retrieve, from a test configuration repository, a test configured to specify at least one predefined input and at least one expected output for the test version of the application, wherein the at least one predefined input comprises at least one instance of recorded user input;
initiate an execution, via the debugger, of the test version of the application with the predefined input from the test retrieved from the test configuration repository; and
determine, based on data collected by the debugger during the execution of the test version of the application with the predefined input, whether the execution of the test version of the application produced the expected output.
